(19) United States
(12) Patent Application Publication
(10) Pub. No.: US 2026/0180012 A1
(43) Pub. Date: Jun. 25, 2026

(54) ANODELESS LITHIUM SECONDARY BATTERY, LITHIUM METAL SECONDARY BATTERY, LITHIUM SECONDARY BATTERY, AND ALL-SOLID-STATE SECONDARY BATTERY COMPRISING AMORPHOUS METAL ALLOY COATING LAYER

(71) Applicant: KOREA UNIVERSITY OF TECHNOLOGY AND EDUCATION INDUSTRY-UNIVERSITY COOPERATION FOUNDATION, Cheonan-si (KR)

(72) Inventors: Suk Jun KIM, Cheonan-si (KR); Jong Gyeom KIM, Cheonan-si (KR); Dong Eun GU, Cheonan-si (KR)

(73) Assignee: KOREA UNIVERSITY OF TECHNOLOGY AND EDUCATION INDUSTRY-UNIVERSITY COOPERATION FOUNDATION, Cheonan-si (KR)

(21) Appl. No.: 19/124,572

(22) PCT Filed: Nov. 22, 2022
(86) PCT No.: PCT/KR2022/018538

§ 371 Date: Apr. 25, 2025

(30) Foreign Application Priority Data
Nov. 7, 2022 (KR) 10-2022-0147409

(51) Int. Cl. H01M 10/0525; H01M 4/36; H01M 10/0569

(52) U.S. Cl. CPC H01M 10/0525; H01M 4/364; H01M 10/0569

(57) ABSTRACT

Disclosed are an anodeless lithium secondary battery, a lithium metal secondary battery, a lithium secondary battery, and an all-solid-state secondary battery comprising a Zr-based amorphous metal alloy and Ti-based amorphous metal alloy coating layer capable of suppressing the generation of a solid-electrolyte interface and dead lithium that are formed on an interface between a Cu current collector and an electrolyte and reduce the coulombic efficiency of an anodeless lithium battery.

### CROSS-REFERENCE TO RELATED APPLICATIONS

This application claims priority under 35 U.S.C. § 119 to Korean Patent Application No. 10-2022-0147409, filed on Nov. 7, 2022, in the Korean Intellectual Property Office, the disclosure of which is incorporated herein by reference in its entirety.

### BACKGROUND

### 1. Field of the Invention

The present invention relates to an anodeless lithium secondary battery, a lithium metal secondary battery, a lithium secondary battery, and an all-solid-state secondary battery comprising an amorphous metal alloy coating layer, and more particularly, to an anodeless lithium secondary battery, a lithium metal secondary battery, a lithium secondary battery, and an all-solid-state secondary battery comprising an amorphous metal alloy coating layer capable of suppressing the generation of a solid-electrolyte interface (SEI) and dead lithium on the surface of a current collector by coating a Zr-based or Ti-based amorphous metal alloy at an interface where a Cu current collector comes into contact with the electrolyte.

### 2. Discussion of Related Art

High energy density is one of the key factors for achieving driving ranges comparable to internal combustion engine vehicles and for extending the operating time of electronic devices. To achieve high energy density, various attempts have been made to modify the cell structure of lithium-ion batteries to achieve higher areal capacity, smaller volume or lower cell weight. Anodeless lithium metal batteries have been considered a promising cell structure for enhancing the energy density of lithium-ion batteries. In anodeless lithium metal batteries, there is no active material for the anode, such as graphite, which allows for reductions in battery weight, volume, and cost compared to commercial lithium-ion batteries. However, the absence of active material for the anode results in a decrease in Coulombic efficiency. Low Coulombic efficiency is a major drawback to the commercialization of anodeless lithium metal batteries, and many attempts have been made to overcome this limitation. The low Coulombic efficiency is mainly due to the excessive consumption of lithium and electrolyte caused by the formation of unstable solid-electrolyte interface (SEI) and dead lithium. The unstable SEI and dead lithium lead to non-uniform lithium deposition or the formation of lithium dendrites on the current collector during charging, which is a result of non-uniform current density on the current collector (CC). Non-uniform surface conditions of the current collector and the intrinsic lithiophobicity of copper (Cu) accelerate the non-uniform lithium deposition.

The sub-millimeter-level roughness of bare Cu induced during the foil manufacturing process leads to non-uniform lithium deposition. In addition, nanoscale roughness caused by defects such as grain boundaries, impurities, and variations in the crystallographic orientation of particles within the current collector also induces non-uniform current density, resulting in non-uniform lithium deposition. In addition to various surface conditions, the lithiophobicity of Cu also results in non-uniform lithium deposition. Cu is known to be a relatively lithiophobic material based on its solid solution and compound-forming properties. Elements that exhibit solubility in lithium and the formation of compounds with lithium, such as gold (Au) and silver (Ag), have been reported to be lithiophilic. Cu, on the other hand, is not soluble in lithium or does not exhibit intermetallic alloying with lithium, and thus exhibits lithiophobic behavior. In the initial stage of lithium deposition, lithium nuclei form on protruding surface areas where the current density is higher than in the surrounding area. Subsequently, due to the lithiophobicity, lithium ions prefer to deposit on the pre-deposited lithium rather than on the surface of the bare Cu current collector. This results in a non-uniform top surface of the deposited lithium and the growth of lithium dendrites.

The uneven top surface of the deposited lithium increases the interfacial area between the electrolyte and the deposited lithium, thereby accelerating the formation of the solid-electrolyte interface (SEI) layer, which leads to a decrease in Coulombic efficiency. The solid-electrolyte interface layer is formed at the interface between the deposited lithium metal and the electrolyte. During the cycle, as lithium ions are repeatedly deposited and stripped on the current collector, the morphology of the deposited lithium changes. This causes cracks to form at the solid-electrolyte interface layer, and the deposited lithium is continuously exposed to the electrolyte. The solid-electrolyte interface continues to form during cycling, which consumes lithium and electrolyte. In addition to lithium consumption caused by the formation of the solid-electrolyte interface, the formation of lithium fragments also results in a decrease in Coulombic efficiency. Lithium fragments are electrochemically inactive because they are lithium dendrites that have detached from the deposited lithium. Lithium dendrites tend to form in regions with high local current density over time in the sand. During lithium stripping and deposition, non-uniform dissolution leads to the formation of lithium fragments, which are referred to as dead lithium. Another drawback of lithium dendrite formation is that it causes short circuits. As lithium dendrites continue to grow, they eventually contact the cathode, resulting in a short circuit.

Numerous attempts have been made to improve the Coulombic efficiency of anodeless lithium metal batteries. Among other things, coating the current collector with various thin films has been evaluated. The coating layers on the current collector have mainly been studied using three types of materials: carbon-based, organic-based, and metal-based materials. Among them, the advantage of metal-based materials lies in their excellent electrical conductivity and strong adhesion to the Cu current collector. The metal coating layer serves as a protective layer that prevents corrosion of the current collector and severe volume changes during cycling. Various types of metals have been investigated as coating layers on the current collector, and it has been demonstrated that lithiophilic metal layers such as silver (Ag), gold (Au), and tin (Sn) promote uniform lithium deposition. During lithium deposition, the coated metal dissolves into the deposited lithium to form a solid solution layer, effectively reducing the nucleation overpotential. In addition to lithiophilic metals, lithiophobic compounds have also been adopted as coating layers. Chemical reactions between lithium and nanostructured lithiophobic materials lead to a lithiophobic-to-lithiophilic conversion that enhances electrochemical performance.

### SUMMARY

To address the above-described problems, the present invention aims to provide an anodeless lithium secondary battery, a lithium metal secondary battery, a lithium secondary battery, and an all-solid-state secondary battery comprising a Zr-based amorphous metal alloy coating layer and a Ti-based amorphous metal alloy coating layer, which are capable of suppressing the generation of a solid-electrolyte interface and dead lithium at the interface between the Cu current collector and the electrolyte that deteriorates the Coulombic efficiency of anodeless lithium batteries.

To achieve the above-described object, an anodeless lithium secondary battery comprising an amorphous metal alloy coating layer according to a first embodiment of the present invention may include: a cathode; a current collector facing the cathode and formed of copper foil; an electrolyte located between the cathode and the current collector; and a separator separating the cathode and the current collector, wherein an interface where the current collector comes into contact with the electrolyte is coated with an amorphous metal alloy.

Additionally, a lithium metal secondary battery comprising an amorphous metal alloy coating layer according to a second embodiment of the present invention may include: a cathode; a lithium metal anode located to face the cathode; an electrolyte located between the cathode and the lithium metal anode; and a separator separating the cathode and the lithium metal anode, wherein a surface of the lithium metal anode is coated with an amorphous metal alloy.

Additionally, a lithium secondary battery comprising an amorphous metal alloy coating layer according to a third embodiment of the present invention may include: a cathode; a lithium metal anode located to face the cathode; a current collector formed of copper foil, which is in contact with the lithium metal anode and located in a direction opposite to the cathode; an electrolyte located between the cathode and the lithium metal anode; and a separator separating the cathode and the lithium metal anode, wherein a surface of the lithium metal anode is coated with an amorphous metal alloy.

Additionally, an all-solid-state secondary battery comprising an amorphous metal alloy coating layer according to a fourth embodiment of the present invention may include: a cathode; an anode located to face the cathode; and a solid electrolyte filled between the cathode and the anode, wherein an amorphous metal alloy layer is present at an interface between the solid electrolyte and the anode.

Furthermore, a current collector according to a fifth embodiment of the present may be an anode current collector having a surface coated with an amorphous metal alloy.

Also, a method of fabricating an anodeless lithium secondary battery comprising an amorphous metal alloy coating layer according to a sixth embodiment of the present invention may be a method of fabricating an anodeless lithium secondary battery including: a cathode; a current collector facing the cathode and formed of copper foil; an electrolyte located between the cathode and the current collector; and a separator separating the cathode and the current collector, wherein the current collector is formed by coating an amorphous metal alloy onto a copper thin film by magnetron sputtering.

In the first to sixth embodiments, the amorphous metal alloy may be selected from any one or a mixture of two or more of lanthanum-based (La), cerium-based (Ce), praseodymium-based (Pr), promethium-based (Pm), samarium-based (Sm), lutetium-based (Lu), yttrium-based (Y), neodymium-based (Nd), gadolinium-based (Gd), terbium-based (Tb), dysprosium-based (Dy), holmium-based (Ho), erbium-based (Er), thulium-based (Tm), thorium-based (Th), calcium-based (Ca), scandium-based (Sc), barium-based (Ba), beryllium-based (Be), bismuth-based (Bi), germanium-based (Ge), lead-based (Pb), ytterbium-based (Yb), strontium-based (Sr), europium-based (Eu), zirconium-based (Zr), thallium-based (Tl), lithium-based (Li), hafnium-based (Hf), magnesium-based (Mg), phosphorus-based (P), arsenic-based (As), palladium-based (Pd), gold-based (Au), plutonium-based (Pu), gallium-based (Ga), germanium-based (Ge), aluminum-based (Al), copper-based (Cu), zinc-based (Zn), antimony-based (Sb), silicon-based (Si), tin-based (Sn), titanium-based (Ti), cadmium-based (Cd), indium-based (In), platinum-based (Pt), and mercury-based (Hg) amorphous metal alloys.

In the first to sixth embodiments, the amorphous metal alloy may be a Zr-based amorphous metal alloy.

In the first to sixth embodiments, the Zr-based amorphous metal alloy may be a compound of ZrₓCu_{y}Ni_{z}Al_{w}, wherein x is in a range of 35 to 70, y is in a range of 20 to 50, z is in a range of 7 to 15, and w is in a range of 3 to 5, and more preferably, x is in the range of 40 to 50, y is in the range of 25 to 35, z is in the range of 10 to 13, and w is in the range of 4 to 5.

In the first to sixth embodiments, the amorphous metal alloy may be a Ti-based amorphous metal alloy, and the Ti-based amorphous metal alloy may include any one of Ti—Cu, Ti—Cu—Al, Ti—Cu—Nb, Ti—Cu—Ni, Ti—Cu—Ni—Sn, Ti—Cu—Ni—Sn—Zr, Ti—Cu—Ni—Zr, Ti—Cu—Ni—Sn—Zr, and Ti—Zr—Si amorphous metal alloys.

In the first to sixth embodiments, the Ti-based amorphous metal alloy may be a compound of TiₐZr_{b}Si_{c}, wherein a is in a range of 45 to 85, b is in a range of 20 to 50, and c is in a range of 5 to 10, and more preferably, a is in the range of 60 to 70, b is in the range of 22 to 28, and c is in the range of 8 to 10.

In the first to sixth embodiments, the coating thickness of the amorphous metal alloy may be in the range of 8 to 500 nm, preferably in the range of 8 to 200 nm, more preferably in the range of 8 to 24 nm, and most preferably in the range of 8 to 16 nm.

The amorphous metal alloy may be a metallic glass.

A method of fabricating an anodeless lithium secondary battery comprising an amorphous metal alloy coating layer of the present invention may include: preparing a lithium foil; and depositing an amorphous metal alloy onto the lithium foil by magnetron sputtering.

Here, the sputtering by the magnetron sputtering may be performed at 10⁻³ to 10⁻⁷ Torr in an inert gas atmosphere for 30 seconds to 3 minutes.

As described above, the present invention has the effect of exhibiting promising cycling performance by suppressing the generation of a solid-electrolyte interface and dead lithium in half cells and full cells of an anodeless lithium secondary battery.

### BRIEF DESCRIPTION OF THE DRAWINGS

FIG. 1(a) shows the Coulombic efficiency of half cells in which the current collectors are coated with Zr-MG thin films having thicknesses of 8 nm, 12 nm, 16 nm, 24 nm, and 32 nm;

FIG. 2(b) shows the voltage profiles of the first-cycle samples of half cells in which the current collectors are coated with Zr-MG thin films having thicknesses of 8 nm, 12 nm, 16 nm, 24 nm, and 32 nm;

FIG. 2(c) shows the voltage profiles of the half cells in which the current collectors are coated with Zr-MG thin films having thicknesses of 8 nm, 12 nm, 16 nm, 24 nm, and 32 nm; and

FIG. 2(d) compares the Coulombic efficiency of a half cell having a current collector coated with 12 nm-thick Zr-MG without heating and with heating at 100° C. for 10 minutes.

FIG. 2(a) shows the overpotentials at 0.1 mAh cm⁻² and 0.5 mAh cm⁻² of half cells with a current collector without 12-MG coating and a current collector with 12-MG coating;

FIG. 2(b) is an SEM image of the lithium deposits after 1 hour at 0.1 mAh cm⁻² on the current collector with 12-MG coating;

FIG. 2(c) is an SEM image of the lithium deposits after 5 hours at 0.5 mAh cm⁻² on the current collector with 12-MG coating;

FIG. 2(d) is an SEM image of the lithium deposits on the current collector with 12-MG coating;

FIG. 2(e) is an SEM image of the lithium deposits after 1 hour at 0.1 mAh cm⁻² on the current collector without 12-MG coating;

FIG. 2(f) is a digital image of the lithium deposits after 5 hours at 0.5 mAh cm⁻² on the current collector without 12-MG coating; and

FIG. 2(g) is a digital image of the lithium deposits on the current collector without 12-MG coating.

FIG. 3(a) is a Nyquist graph of bare Cu and 12-MG coated current collectors measured by electrochemical impedance spectroscopy (EIS) after the first discharge cycle following a pre-cycle; and

FIG. 3(b) is a Nyquist graph of bare Cu and 12-MG coated current collectors after the 100th discharge cycle.

FIG. 4(a) shows an SEM image (magnification ×100,000) of lithium deposits after 1 hour at 0.1 mAh cm⁻² on bare Cu;

FIG. 4(b) shows an SEM image (magnification ×100,000) of lithium deposits after 1 hour at 0.1 mAh cm⁻² on the current collector coated with 12-MG;

FIG. 4(c) is a top surface image of bare Cu without lithium deposits; and

FIG. 4(d) is a top surface image of the current collector coated with 12-MG without lithium deposits.

FIG. 5(a) shows the XPS profiles of Zr on the top surface of the deposited 12-MG coated current collector at 0.5, 1.0, and 6.5 cycles;

FIG. 5(b) is a TEM image of the deposited 12-MG; and

FIG. 5(c) is a TEM image of the 12-MG after 1 cycle.

FIG. 6 shows the cycling performance of full cells assembled with LiFePO₄ as the counter electrode and bare Cu, 12-MG, and 16-MG coated current collectors at a rate of 0.2 C.

FIG. 7(a) is a SEM image of a top surface of deposited lithium on a 12-MG coated current collector after the first deposition at a rate of 0.2 C in a full cell having an LFP cathode (1 mAh/cm²);

FIG. 7(b) is a SEM image of a top surface of deposited lithium on a bare Cu current collector after the first deposition at a rate of 0.2 C in a full cell having an LFP cathode (1 mAh/cm²);

FIG. 7(c) is a SEM image of a top surface of deposited lithium on a 12-MG coated current collector after the 100th deposition at a rate of 0.2 C in a full cell having an LFP cathode (1 mAh/cm²);

FIG. 7(d) is a SEM image of a top surface of deposited lithium on a bare Cu current collector after the 100th deposition at a rate of 0.2 C in a full cell having an LFP cathode (1 mAh/cm²);

FIG. 7(e) is a cross-sectional SEM image of deposited lithium on a 12-MG coated current collector after the first deposition at a rate of 0.2 C in a full cell having an LFP cathode (1 mAh/cm²);

FIG. 7(f) is a cross-sectional SEM image of deposited lithium on a bare Cu current collector after the first deposition at a rate of 0.2 C in a full cell having an LFP cathode (1 mAh/cm²);

FIG. 7(g) is a cross-sectional SEM image of deposited lithium on a 12-MG coated current collector after the 100th deposition at a rate of 0.2 C in a full cell having an LFP cathode (1 mAh/cm²); and

FIG. 7(h) is a cross-sectional SEM image of deposited lithium on a bare Cu current collector after the 100th deposition at a rate of 0.2 C in a full cell having an LFP cathode (1 mAh/cm²).

FIG. 8 shows the discharge capacity over cycling of bare lithium in a full cell, under the conditions of 1.5 mA/cm², an electrolyte of DOL/DME 1M LiTFSI+2 wt % LiNO₃, and a charge/discharge rate of 1.0 C.

FIG. 9(a) shows the discharge capacities over cycling of anodes coated with Zr-based amorphous metal alloys having thicknesses of 12 nm and 200 nm in a full cell, under the conditions of 1.5 mA/cm², an electrolyte of DOL/DME 1M LiTFSI+2 wt % LiNO₃, and a charge/discharge rate of 1.0 C; and

FIG. 9(b) shows the relationship between cycling and peak values for five Zr-based amorphous metal alloys.

FIG. 10(a) shows the discharge capacity over cycling of an anode coated with a 12 nm-thick Ti-based amorphous metal alloy in a full cell, under the conditions of 1.5 mA/cm², an electrolyte of DOL/DME 1M LiTFSI+2 wt % LiNO₃, and a charge/discharge rate of 1.0 C; and

FIG. 10(b) shows the relationship between cycling and peak values for two Ti-based amorphous metal alloys.

### DETAILED DESCRIPTION OF EMBODIMENTS

The present invention may be subject to various modifications and may have a variety of embodiments, and specific embodiments are illustrated in the drawings and described in detail in the detailed description. However, this is not intended to limit the present invention to the specific embodiments, but it should be understood to include all modifications, equivalents, and substitutions that fall within the spirit and scope of the present invention. In the description of each drawing, similar reference numerals have been used for similar components.

The terms such as first, second, A, and B may be used to describe various components, but the components should not be limited by these terms. These terms are only used for the purpose of distinguishing one component from another.

For example, the first component may be referred to as the second component without departing from the scope of the present invention, and similarly, the second component may also be referred to as the first component. The term “and/or” includes a combination of a plurality of related listed items or any one of a plurality of related listed items.

When a component is referred to as being “connected” or “coupled” to another component, it should be understood that the component may be directly connected or coupled to the other component, or that one or more other components may be interposed therebetween. In contrast, when a component is referred to as being “directly connected” or “directly coupled” to another component, it should be understood that there are no components interposed therebetween.

The terminology used in the present application is intended only to describe specific embodiments and is not intended to limit the scope of the present invention. Unless clearly indicated otherwise from the context, the singular expressions include the plural expressions. In the present application, terms such as “comprise” or “have” are intended to indicate the presence of features, numerals, steps, operations, components, parts, or combinations thereof described in the specification, and are not intended to preclude the presence or addition of one or more other features, numerals, steps, operations, components, parts, or combinations thereof.

Unless otherwise defined, all terms used herein, including technical and scientific terms, have the same meaning as commonly understood by one of ordinary skill in the art to which the present invention pertains. Terms that are generally defined in dictionaries should be interpreted as having meanings consistent with the contextual meaning in the relevant technical field, and should not be interpreted in an idealized or overly formal sense unless explicitly defined in the present application.

In the present invention, a Zr₅₄Cu₃₁N₁₁Al₄, Zr-based amorphous metal alloy was used as a coating on the Cu current collector, which significantly improved the electrochemical performance of the anodeless lithium metal battery. A 12 nm-thick Zr-based amorphous metal alloy thin film was deposited by magnetron sputtering. The amorphous metallic alloy is an amorphous metallic alloy that exhibits glass-like behavior such as glass transition during heating. Its amorphous structure offers many advantages in enhancing the electrochemical properties of the current collector. First, amorphous materials without long-range order provide a uniform environment for lithium deposition because they do not contain defects such as grain boundaries, dislocation, or stacking faults. This eliminates atomic-scale roughness and the variability of crystallographic orientation and composition. In Zr-MG (Zr-Metallic Glass) thin films, short-range or medium-range order results in chemical and physical uniformity of the surface, which leads to uniform lithium deposition during charging. Second, the amorphous structure possesses a disordered phase with a large number of atomic vacancies and exhibits higher elasticity compared to crystalline alloys, thereby providing more lithium ion insertion sites. More lithium insertion sites offer a lithiophilic environment, and the inserted lithium converts the Zr-MG into a lithiophilic phase. Zirconium (Zr), the main component of Zr-MG, is classified as a lithiophobic element due to its poor solubility in lithium and the absence of intermetallic formation with lithium. However, Zr reacted with lithium ions to form a lithiophilic Li₂ZrO₃ thin film. The lithiophilic Zr—Li phase on top of the Zr-MG thin film induces uniform lithium deposition. In general, amorphous metallic alloys exhibit excellent mechanical properties such as mechanical strength and elasticity, and are therefore primarily regarded as structural materials. The research community on amorphous metallic alloys has mainly focused on their mechanical properties and glass-forming ability. To the best of our knowledge, amorphous metal alloys have not been considered as coatings for current collectors so far. The Zr-MG thin film, which possesses atomic-scale uniformity, the number of atomic vacancies, excellent elasticity, and the formation of a lithiophilic Zr—Li phase, leads to uniform lithium deposition on the current collector. The uniform lithium deposition in the initial stage of deposition ultimately resulted in a significant reduction in solid-electrolyte interface resistance (R_{SEI}) and charge transfer resistance (R_{ct}), leading to excellent electrochemical performance.

### [Method of Preparing Zr-MG Target]

To create a high vacuum state, the diffusion pump is preheated for about 1 hour before operating the arc melter equipment. Zr, Cu, Ni, and Al elements were placed into the arc melter main chamber, and the chamber was evacuated to 10⁻³ Torr or less using a rotary pump, and further evacuated to 10⁻⁵ Torr or less using a diffusion pump. Once a high vacuum state was achieved, Ar gas was introduced by opening the gas valve, and the sample was melted using an arc beam to prepare a Zr₅₄—Cu₃₁—Ni₁₁—Al₄ (at %) sputtering target. The prepared target had a height of 11.72 mm and a diameter of 50.53 mm, which made it unsuitable for the sputtering target holder. Therefore, it was cut to a height of 4.78 mm using a wire-cutting machine, and both surfaces were polished to ensure surface flatness and symmetry.

### [Method of Preparing Electrodes]

The prepared Zr₅₄—Cu₃₁—Ni₁₁-Al₄ target was deposited onto clean Cu foil using a magnetron sputtering system (a base pressure in the sputtering chamber is 4×10−6 Torr or less). Zr₅₄—Cu₃₁—Ni₁₁-Al₄ was sputtered at DC 125 W under an Ar atmosphere of 5×10⁻³ Torr, either with the Cu foil heated to 373.15K or without heating (R.T). The Cu foil coated with Zr₅₄—Cu₃₁—Ni₁₁—Al₄ and heat-treated at 373.15 K was left in the vacuum sputtering chamber until it cooled to 300.15K. To prepare the cell, the current collector coated with Zr₅₄—Cu₃₁—Ni₁₁—Al₄ was transferred directly into the glove box through the gate without exposure to air after the sputtering process.

### [Method of Preparing a Cell]

Zr₅₄—Cu₃₁—Ni₁₁—Al₄/Cu foil was cut to a diameter of 18 mm and used as the working electrode, and Li metal was cut to a diameter of 16 mm and used as the counter electrode in the half cell. The cell was prepared in a glove box under an Ar atmosphere (02<1 ppm, H2O<1 ppm) using a CR2032 coin cell model. The half cell was prepared in the order of a case, an 18 mm electrode, a separator (Celgard 2400), an electrolyte (1M lithium bis(trifluoromethanesulfonyl)imide (LiTFSI) in 1:1 1,3-dioxolane/1,2-dimethoxyethane (DOL/DME) with 2 wt % lithium nitrate (LiNO₃)) 70 μL, 16 mm lithium metal, a spacer, a wave spring, and a cap.

Zr₅₄—Cu₃₁—Ni₁₁—Al₄/Cu foil with a diameter of 16 mm was used as the anode and LiFePO₄ (LFP) with a diameter of 14 mm was used as the cathode in the full cell. The ratio of LFP/carbon black/poly(vinylidene fluoride) was 8:1:1, and the areal capacity of the cathode was 1.0 mAh/cm². The cell was prepared in a glove box under an Ar atmosphere (02<1 ppm, H2O<1 ppm) using a CR2032 coin cell model. The full cell was prepared in the order of a case, 14 mm LFP, a separator (Celgard 2400), an electrolyte (1 M lithium bis(trifluoromethanesulfonyl)imide (LiTFSI) in 1:1 1,3-dioxolane/1,2-dimethoxyethane (DOL/DME) with 2 wt % lithium nitrate (LiNO₃)) 70 μL, 16 mm anode, a spacer, a wave spring, and a cap.

### [Cell Performance Evaluation]

Cell performance was evaluated using the WBCS 3000Le system after 24 hours of aging at room temperature. For impedance measurements, electrochemical impedance spectroscopy (EIS) was conducted at room temperature using a Zive SP2 in the frequency range of 1 MHz to 100 mHz with an amplitude of 5 mV. ZMAN software was used to fit the EIS data.

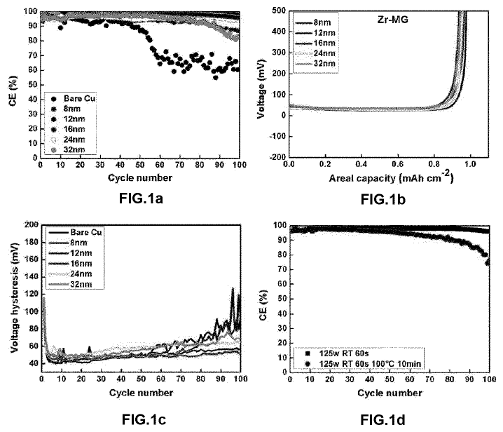

The thickness of the coating layer was optimized by analyzing the Coulombic efficiency of half cells having current collectors coated with Zr-MG thin films of various thicknesses ranging from 8 nm to 32 nm. The amorphous structure and composition of the Zr-MG thin films were confirmed by XRD and SEM EDS. In FIGS. 1(a), 1(b), and 1(c), to compare cell performance per thickness, half cells with Zr-MG thicknesses of 8, 12, 16, 24, and 32 nm were prepared by depositing at a rate of 3.75 s per 1 nm under 125W at room temperature (RT) (a bare Cu half cell was also prepared for comparison). Subsequently, charge/discharge tests were conducted at 1.0 mA/cm² and 1.0 mAh/cm² to evaluate the performance of the electrode. In FIG. 1(d), the 12 nm and 16 nm electrodes showed a tendency to exhibit better characteristics in terms of Coulombic efficiency, voltage profile, and voltage hysteresis than the other thicknesses, so only one of the two conditions (16 nm) was used to compare the difference depending on whether heat treatment was applied. The electrode without heat treatment was deposited at a thickness of 16 nm at room temperature (RT), and the electrode with heat treatment underwent additional heat treatment at 373.15K for 10 minutes after sputtering. Subsequently, charge/discharge tests were conducted at 1.0 mA/cm² and 1.0 mAh/cm² to evaluate the performance of the electrode. As shown in FIG. 1(a), the Coulombic efficiency was improved by depositing a Zr-MG layer on the current collector, compared to the uncoated current collector. Current collectors coated with Zr-MG thin films of 12 nm and 16 nm thickness exhibited more stable and higher Coulombic efficiency than those that were uncoated or coated with thinner or thicker Zr-MG films. In the half cell, the Coulombic efficiency at the 100th cycle for the current collectors coated with 12-MG and 16-MG was 97.8% (97.8±0.60%) and 97.5% (97.7±0.60%), respectively (see Table 1).

TABLE 1

| | Bare Cu | 8 nm | 12 nm | 16 nm | 24 nm | 32 nm |
|---|---|---|---|---|---|---|
| CE at | 60.3 | 87.5 | 97.8 | 95.9 | 90.4 | 82.3 |
| 100 cycles | | | | | | |
| Average CE | 80.3 ± 14.5 | 94.3 ± 2.51 | 97.8 ± 0.60 | 97.7 ± 0.60 | 95.0 ± 1.80 | 94.7 ± 4.40 |

(Unit %)

A smaller standard deviation of the average Coulombic efficiency demonstrated more stable cycling performance of the current collectors coated with 12-MG and 16-MG, and it is considered that the Zr-MG with a thickness of 8 nm was insufficient to improve the cycling performance. A Zr-MG layer thicker than 24 nm may increase internal electrical resistance and deteriorate the electrochemical performance of the current collector. The corresponding voltage profiles of the half-cells in the first cycle in FIG. 1(b) are also 12-24 nm, showing that the Zr-MG-coated current collector exhibits higher capacity compared to the others. Their voltage hysteresis (FIG. 1(c)) confirms that a low hysteresis voltage is maintained due to the Zr-MG coating. For Zr-MGs with thicknesses of 8 nm and 32 nm, the voltage increased rapidly after 70 cycles. The increase in hysteresis voltage was closely correlated with the decrease in Coulombic efficiency in FIG. 1(a). Based on Coulombic efficiency and voltage history data, the optimal thickness for the coating layer on the current collector was in the range of 12 nm to 16 nm. Along with the optimization of the Zr-MG film thickness, the effect of the heated Zr-MG coating on the electrochemical performance was evaluated. After the deposition of 12-MG, annealing the current collector at 100° C. for 10 minutes in a sputtering vacuum chamber decreased the Coulombic efficiency as shown in FIG. 1(d). Although heated 12-MG did not crystallize until 400° C., it is possible to change the atomic composition of Zr-MG by relaxation. Amorphous metal alloys exist in a nonequilibrium state, and the evolution of their atomic structure toward equilibrium is induced by thermal relaxation. This demonstrates that the relaxation of the amorphous metal alloy coating on the current collector detrimentally affects the electrochemical performance of the current collector.

The 12-MG coating explicitly changed the overpotential measured during lithium deposition in the first cycle. The overpotential is a measurable physical parameter for the nucleation and growth of lithium on the current collector, and is obtained from the voltage measured over time under constant current conditions. The overpotential curve shows a deep spike followed by a stabilization region. The overpotential for lithium nucleation in the current collector is the sum of charge transfer, diffusion, reaction, and crystallization overpotentials. Alternatively, the electrode polarization during lithium deposition on the current collector is considered to be the sum of two terms: The nucleation overpotential (ηₙ), observed as a voltage spike related to the nucleation of lithium clusters at the initial stage of deposition, and the growth overpotential (ηₚ), which describes the growth of lithium on pre-existing lithium nuclei and is observed as an almost flat voltage profile. The spike voltage of the 12-MG coated current collector (Zr—CC) was 52 mV, which is 13 mV lower than the 65 mV of the bare current collector. The growth overpotential of the Zr—CC measured after 5 hours of deposition was 13 mV, lower than the 21 mV of the bare current collector. The nucleation overpotentials, which are the differences between the spike potential and the growth potential of Zr—CC and the bare current collector, are 39 mV and 44 mV, respectively. Although the difference was not large, it can be seen that the overall overpotential slightly decreased by depositing an amorphous metal alloy thin film on the current collector. Compared to the overpotential values, the shapes of the overpotential curves were clearly different. In the case of Zr—CC, after the voltage spike, the voltage rapidly increased and reached saturation after 1 hour of deposition. In the case of bare Cu, the voltage continued to increase up to 5 hours without reaching saturation. This difference is considered to result from the differences in four types of overpotentials between the bare current collector and the Zr—CC. Among the four overpotentials, the charge transfer, diffusion, and crystallization overpotentials are expected to mainly cause the difference in the overpotential profiles. This is because it is expected that there is no significant difference in the chemical reactions before and after lithium deposition, regardless of whether the current collector is coated. Differences in interface properties between the deposited Li/Cu interface and the deposited Li/Zr—CC interface in the nucleation regime, and morphological differences in lithium deposition in the growth regime induced differences in the overpotentials of charge transfer, diffusion, and crystallization. Based on the overpotential profile, it can be assumed that once lithium ions begin to deposit on the Zr—CC, atomic nuclei are formed within one hour and uniformly cover the current collector, compared to bare Cu. Lithium continues to deposit on top of the nuclei in the growth regime. For bare Cu collectors, nuclei appear to be continuously formed while existing nuclei grow, suggesting that the nucleation and growth regimes overlap extensively.

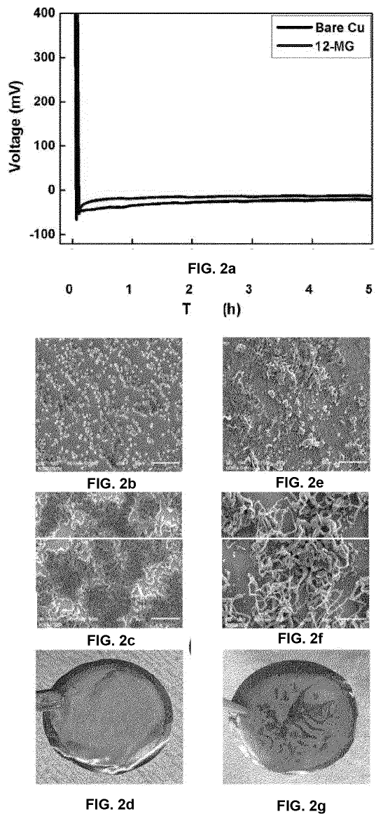

In FIG. 2(a), half cells were prepared using a 12 nm-thick Zr MG-coated current collector and bare Cu, and charging was performed at 0.1 mA/cm² and 0.5 mAh/cm² to compare the overpotentials. In FIG. 2(b) and FIG. 2(e), half cells were prepared using a 12 nm-thick Zr MG-coated current collector and bare Cu, and after charging for 1 hour at a current density of 0.1 mA/cm², the cells were disassembled. If necessary, the sample was rinsed with 1,2-dimethoxyethane (DME) to remove any remaining Li salts. The surface was then examined by SEM at ×500 magnification. In FIG. 2(c) and FIG. 2(f), half cells were prepared using a 12 nm-thick Zr MG-coated current collector and bare Cu, and after charging for 5 hours at a current density of 0.1 mA/cm², the cells were disassembled. If necessary, the sample was rinsed with 1,2-dimethoxyethane (DME) to remove any remaining Li salts. The surface was then examined by SEM at ×500 magnification. In FIG. 2(d) and FIG. 2(g), half cells were prepared using a 12 nm-thick Zr MG-coated current collector and bare Cu, and after charging for 5 hours at a current density of 0.1 mA/cm², the cells were disassembled, and images of the electrode with deposited lithium were captured. Lithium deposits were analyzed by SEM to investigate the relationship between the morphology of the lithium deposits and the overpotential (FIG. 2(b) to FIG. 2(g)). At the initial stage of lithium deposition (1-hour deposition, 0.1 mAh/cm²), lithium was deposited in a granular form on the Zr—CC, whereas on bare Cu, lithium was deposited in both granular and dendritic forms (FIG. 2(b) and FIG. 2(d)). If the number of nuclei on Zr—CC and bare Cu is proportional to either granules or dendrites, they were similar to each other. This may be due to the comparable nucleation overpotential. After 5 hours of deposition (0.5 mAh/cm²), lithium grew uniformly on the Zr—CC, covering a larger area of the current collector, while the tendency for dendritic growth on bare Cu became evident, and as shown in FIG. 2(c) and FIG. 2(e), a larger portion of the current collector area remained uncovered by lithium on the bare Cu. In FIG. 2(f) and FIG. 2(g), uniform growth over the entire area of the Zr—CC can be visually confirmed, whereas only about 75% of the area was covered with lithium on the bare Cu. This clearly demonstrates that lithium was uniformly deposited on the current collector by the 12-MG coating, and a larger deposition area means a lower effective current density (mAh/cm⁻²) under constant current conditions. As shown in the SEM images of FIG. 2, the low effective current density extended the Sand time and minimized dendrite growth on the Zr—CC.

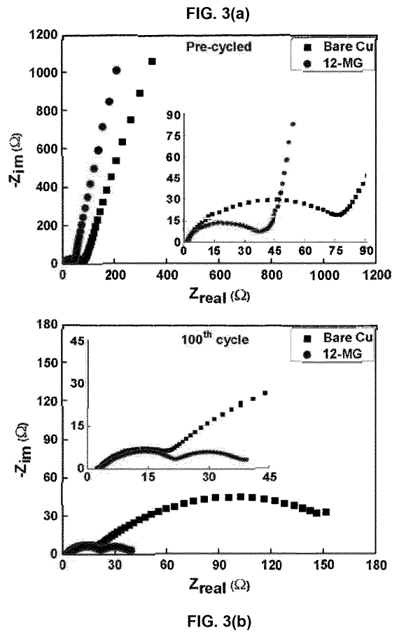

In FIG. 3(a), a half cell was prepared using a 12 nm-thick Zr MG-coated current collector and bare Cu, and EIS was conducted after the pre-cycle to measure the impedance.

In FIG. 3(b), a half cell was prepared using a 12 nm-thick Zr MG-coated current collector and bare Cu, and EIS was conducted after 100 cycles to measure the impedance.

Electrochemical impedance spectroscopy (EIS) measurements clearly show that the 12-MG coating significantly reduced the SEI resistance (R_{SEI}) and charge transfer resistance (R_{ct}) During the first cycle, the R_{SEI} and R_{ct} of the Zr—CC were 38.2Ω and 58.5Ω, respectively, which were much lower than those of the bare current collector, 76.5Ω and 255.9Ω. Even after 100 cycles, the resistance of the Zr—CC remained lower than that of the bare current collector. After 100 deposition processes, the R_{SEI} and R_{ct} of the Zr—CC (21.3Ω and 11.4Ω) were confirmed by EIS to be relatively lower than those of the bare Cu (17.8Ω and 146.8Ω) (FIG. 3(b)). Therefore, the 12-MG coating reduced R_{SEI} and R_{ct}, which are required to induce low nucleation and stable overpotentials.

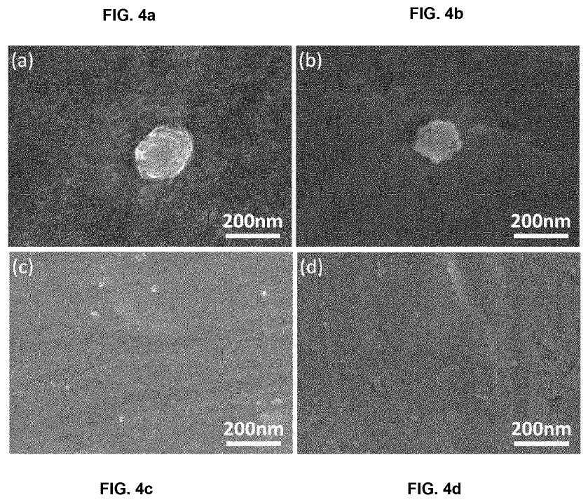

The reductions in overpotential, R_{SEI}, and R_{ct} due to the 12-MG coating led to differences in the nanometer-scale morphology of the lithium deposits. In FIG. 2(b) and FIG. 2(d), the current collector areas without lithium granules or dendrites were examined under magnification using SEM and are presented in FIG. 4. In FIG. 4(a) and FIG. 4(b), half cells were prepared using bare Cu and a 12 nm-thick Zr MG-coated current collector, and after charging for 1 hour at a current density of 0.1 mA/cm², the cells were disassembled. If necessary, the sample was rinsed with 1,2-dimethoxyethane (DME) to remove any remaining Li salts. The surface was then observed at ×100,000 magnification using field emission scanning electron microscopy (FE-SEM). In FIG. 4(c) and FIG. 4(d), the surfaces of bare Cu and a 12 nm-thick Zr MG-coated current collector were observed at ×100,000 magnification using FE-SEM. On the bare Cu current collector, several granules with a diameter of approximately 200 nm were present, as shown in FIG. 4(a), and smaller granules (nano-granules) with a diameter of about 20 nm covered the bare current collector. It is presumed that nuclei were formed at the initial stage of deposition on the bare Cu and grew to about 20 nm within one hour. Boundaries and voids between the nanoparticles were observed on the bare Cu. In the case of 12-MG, the nanoparticles were closely packed and formed a smooth and nearly continuous lithium film, as shown in FIG. 4(b). Boundaries or voids between the nano-granules were rarely observed. By comparing the surface conditions of bare Cu (FIG. 4(c)) and Zr—CC (FIG. 4(d)) without lithium deposition, it was confirmed that nanoparticles were formed on both the bare Cu and Zr—CC. Morphological studies at high magnification by SEM demonstrate the formation of lithium thin films at the initial stage of lithium deposition. Fine particles and lithium dendrites are formed on top of the lithium thin film. The formation of a nearly continuous lithium film on the Zr—CC supports the sharp drop in overpotential following the voltage spike (see FIG. 2(a)).

In contrast, the discontinuous lithium film on the bare current collector allowed lithium ions to deposit on both the bare current collector and the Li film, that is, in both the overlapping nucleation regime (formation of nanoparticles) and the growth regime (formation of microparticles and lithium dendrites). Accordingly, as shown in FIG. 2(a), the overpotential of the bare Cu continuously decreased.

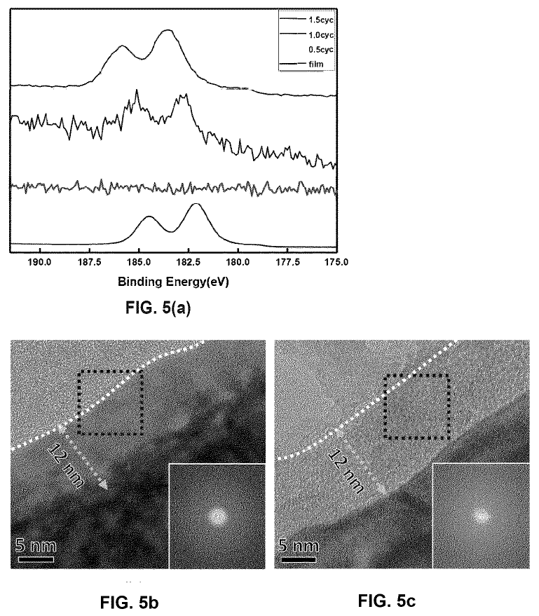

As previously mentioned, the overpotential decreased when 12-MG was coated on the Cu current collector, and as shown in FIG. 2(a), the overpotential clearly dropped after the voltage spike. This is due to the reduction in charge transfer overpotential, diffusion (in the SEI) overpotential, and/or crystallization overpotential. The reduction in charge transfer and diffusion overpotentials was estimated through the EIS measurements in FIG. 3. The reduction in crystallization may be another reason for the overall decrease in overpotential caused by the 12-MG coating. The conversion reaction and/or homogeneity of 12-MG, which are intrinsic properties of amorphous metal alloys, may reduce the crystallization overpotential. First, it was expected that after lithium diffused into the 12-MG and lithium deposition occurred, the 12-MG would be converted from a lithiophobic coating to a lithiophilic coating. The conversion of 12-MG is supported by XPS in FIG. 5. The Zr binding energy profile from the deposited 12-MG consists of previously reported Zr binding energies from Zr-based amorphous metal alloys. After 0.5 cycle (lithium deposition), Zr was not detected on the lithium deposit, which indicates that 12-MG acted as a seed layer. After 1.0 cycle (lithium stripping), the Zr binding energy increased by 0.5 to 0.6 eV, indicating that Zr was oxidized. After 1.5 cycles (lithium deposition), when the lithium deposit was removed and the Zr binding energy was analyzed, it also increased by 0.5 to 0.6 eV, indicating that oxidation of Zr had progressed. That is, as the number of deposition cycles on the current collector increases, it can be seen that the 12-MG remains in an oxidized state compared to the pre-cycled 12-MG thin film. The crystallization overpotential (i) arises because it interferes with the incorporation of adsorbed atoms into the electrode. Adsorbed atoms located on the electrode surface from the electrolyte diffuse into the growth phase and eventually reach a stable growth site such as a kink. The Nernst equation primarily can be used to estimate η_{c}, which depends on the ratio of the concentration (or activity) of adsorbed atoms at the growth site and in the vicinity of the growth site. A higher the η_{c}, a higher concentration of adsorbed atoms in the surface areas farther from the growth site. This is interpreted as being due to the diffusion rate of adsorbed atoms being slower than their reaction rate at steps and kinks. When the surface diffusivity decreases, the surface diffusion penetration length (λ₀) becomes shorter. The average current density (i) is a function of the overpotential, the distance between two incident growth sites (2x₀), and λ₀ under steady-state conditions.

$$i = {i}_{0} [ exp ( \frac{α zF}{RT} η ) - exp ( - \frac{( 1 - α ) zF}{RT} η ) ] for {λ}_{0} / {x}_{0} >> 1 \qquad ( Equation 1 )$$

$$i = \frac{{λ}_{0}}{{x}_{0}} {i}_{0} [ exp ( \frac{α zF}{RT} η ) - exp ( - \frac{( 1 - α ) zF}{RT} η ) ] for {λ}_{0} / {x}_{0} << 1 , \qquad ( Equation 2 )$$

$$wherein ,$$

$${λ}_{0} = \sqrt{\frac{zFD \overline{c}}{{i}_{0}}} \cdot exp ( \frac{α zF}{2 RT} η ) .$$

In Equation 1 and Equation 2 above, i₀, α, z, F, R, T, D, and c represent the exchange current density, charge transfer coefficient, charge transfer number, Faraday constant, gas constant, temperature, surface diffusivity, and the equilibrium concentration of adsorbed atoms (when η=0), respectively. Since the overpotential in FIG. 2(a) was measured under constant current, it can be assumed that the overpotential was measured under steady-state conditions. Equation 1 (λ₀/x₀>>1) indicates a pure charge transfer current density, meaning that crystallization is not hindered. In contrast, Equation 2 (λ₀/x₀<<1)) represents the relationship between the current and the pure crystallization overpotential. In this case, the effective charge transfer coefficient in Equation 2 is reduced to half of that in Equation 1 when the exponential term of λ₀ is multiplied by η. According to Equation 1 and Equation 2, when the crystallization overpotential becomes dominant, the significance of λ₀/x₀ increases in the equation. As μ₀/x₀ increases, η_{c} in Equation 2 decreases under constant current conditions. According to Equation 2, the fact that the growth overpotential for Zr—CC is lower than that for bare Cu in FIG. 2(a) implies that the diffusivity of adsorbed atoms on Zr—CC is higher (i.e., the larger the λ₀), and that the distance between adjacent nuclei is shorter (i.e., the smaller the x₀). Since a lower overpotential results in a smaller number of nuclei, a smaller x₀ can be achieved by forming 2D-shaped nuclei. 2D-shaped nuclei are known to form on the surface without defects such as dislocations or grain boundaries. In the initial stage of lithium deposition (see FIG. 4), the flat and uniform Li layer on Zr—CC also supports the formation of 2D-shaped nuclei on Zr—CC. As μ₀/x₀ increases, the current density decreases because the adsorbed atoms are also more uniformly distributed. Therefore, the Zr-MG coating helps to form 2D-shaped nuclei, increases surface diffusivity, and prevents dendrite formation by reducing the local current density.

It is clearly shown in Equation 2 above that the reduction in crystallization overpotential is due to the uniformity of the Zr-MG thin film. This is supported by the results that crystallization of Zr-MG leads to a decrease in Coulomb efficiency. In FIG. 5(a), a half cell was prepared using a 12 nm-thick Zr MG-coated current collector, and the cell was disassembled after 0.5, 1.0, and 1.5 cycles at 1.0 mA/cm² and 1.0 mAh/cm², respectively. If necessary, the sample was rinsed with 1,2-dimethoxyethane (DME, Sigma Aldrich) to remove any remaining Li salts. Subsequently, XPS (X-ray Photoelectron Spectroscopy) analysis was conducted on a total of four samples, including the three disassembled electrodes and the current collector coated with 12 nm-thick Zr-MG. In FIG. 5(b) and FIG. 5(c), a half cell was prepared using a 12 nm-thick Zr MG-coated current collector, and the cell was disassembled after 1.0 cycle at 1.0 mA/cm² and 1.0 mAh/cm². If necessary, the sample was rinsed with 1,2-dimethoxyethane (DME, Sigma Aldrich) to remove any remaining Li salts. Subsequently, images of a total of two samples, the electrode after 1.0 cycle and the current collector coated with 12 nm-thick Zr-MG, were observed by TEM at ×600,000 magnification. The amorphous structure of 12-MG was maintained upon lithium deposition/stripping, which was confirmed by TEM analysis as shown in FIG. 5(c) and FIG. 5(d).

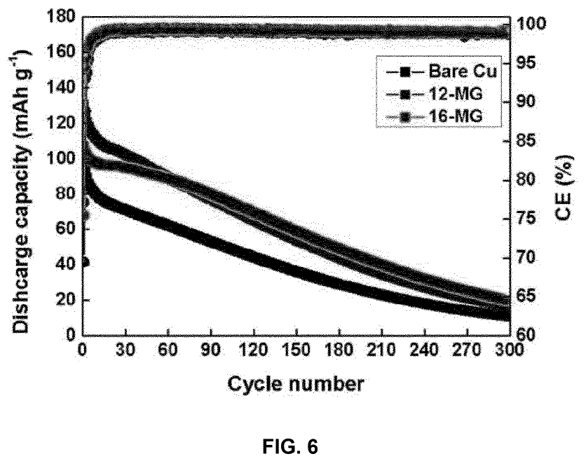

In FIG. 6, full cells were prepared using 12 nm- and 16 nm-thick Zr MG, which exhibited excellent performance in half cells (bare Cu half cells were also prepared for comparison). In the full cell, LiFePO₄ was used as the cathode, with a capacity of 1 mAh/cm². In the full cell, 70 μL of electrolyte (1 M lithium bis(trifluoromethanesulfonyl)imide (LiTFSI) in 1:1 1,3-dioxolane/1,2-dimethoxyethane (DOL/DME) with 2 wt % lithium nitrate (LiNO₃)) was used. This was followed by a charge and discharge at a 0.2 C-rate, with a voltage range of 3.0 to 3.8 V.

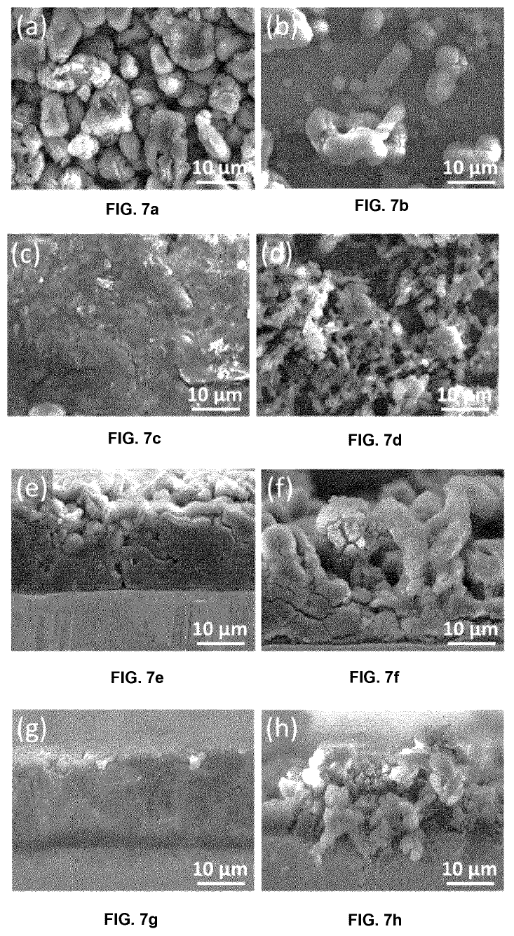

In FIG. 7(a), FIG. 7(b), FIG. 7(e), and FIG. 7(f), full cells were prepared using a 12 nm-thick Zr MG-coated current collector and bare Cu, and after the first charge cycle at 0.2 C-rate, the cells were disassembled. If necessary, the sample was rinsed with 1,2-dimethoxyethane (DME) to remove any remaining Li salts. The surface/cross-section was then examined by SEM at ×2,000 magnification. In FIG. 7(c), FIG. 7(d), FIG. 7(g), and FIG. 7(h), full cells were prepared using a 12 nm-thick Zr MG-coated current collector and bare Cu, and after the hundredth charge cycle at 0.2 C-rate, the cells were disassembled. If necessary, the sample was rinsed with 1,2-dimethoxyethane (DME) to remove any remaining Li salts. The surface/cross-section was then examined by SEM at ×2,000 magnification. The 12-MG coating layer on the current collector improved the cycling performance of the full cell using LiFePO₄ as the cathode material. The full cell of 15Ph5 exhibited a primary discharge capacity of 130.7 mAhg⁻¹. The capacity retention after 100 cycles was 56.0%, with an average Coulombic efficiency of 99.4%. Uniform coating of 12-MG on the current collector is a creative method to achieve excellent electrochemical performance in anodeless lithium metal batteries, because the amorphous structure of the anodeless lithium metal battery provides uniform nucleation sites, and the sites become more favorable when lithium is absorbed. In addition, the electrical conductivity of 12-MG is advantageous in reducing series resistance. To the best of our knowledge, although the use of amorphous metal alloys as active electrode materials in lithium-ion batteries has been reported, thin films of amorphous metal alloys as seed layers on current collectors have not been investigated. In contrast, for the full cell with bare Cu, the first discharge capacity was 106.0 mAhg⁻¹. After 100 cycles, the capacity retention was only about 47.3%, and the average Coulombic efficiency ranged from 90% to 99%. The first discharge capacity of 12-MG was approximately 23% higher than that of bare Cu. This appears to demonstrate the advantage of 12-MG as a seed layer. The top and cross-sectional morphology of the lithium after primary deposition (shown in FIG. 7) exhibited more densely deposited Li on 12-MG compared to bare Cu demonstrating a higher primary discharge capacity on 12-MG, and the cross-sectional image shows that the uniformity of thickness decreases slightly even after 100 cycles, leading to densely deposited Li. For bare Cu, discontinuous and non-uniform lithium deposition occurred.

### Method of Preparing an Electrode (Anode)

An anode was prepared by cutting lithium foil with a thickness of 200 μm into a diameter of 16 mm.

### Method of Preparing a Cell

For preparing a full-cell, a CR2032 coin cell was used, and the cell was prepared inside a glove box under an Ar atmosphere (O₂<1 ppm, H₂O<1 ppm). 1M lithium bis(trifluoromethanesulfonyl)imide (LiTFSI) in a 1:1 1,3-dioxolane/1,2-dimethoxyethane (DOL/DME) with 2 wt % lithium nitrate (LiNO₃) was used for the electrolyte, and LiFePO₄ (LFP:Super P:PVDF=8:1:1) with a capacity of 1.5 mAh/cm² was used for the cathode. The full cell was prepared in the order of a case, an anode (lithium metal with a diameter of 16 mm), a separator (Celgard 2400), 70 μL of electrolyte, a gasket, a cathode (LFP with a diameter of 14 mm), a spacer, a wave spring, and a cap.

### [Cell Test Conditions]

Full cell testing was performed at a rate of 1.0 C and a voltage range of 3.0 V-3.8 V.

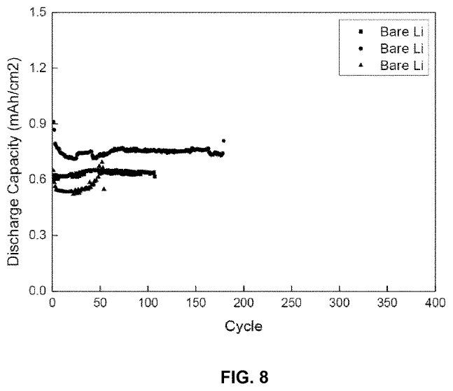

Referring to FIG. 8, in the lithium metal secondary battery including a cathode, a lithium metal anode, an electrolyte, and a separator, under the conditions of 1.5 mA/cm², an electrolyte of DOL/DME 1M LiTFSI+2 wt % LiNO₃, and a charge/discharge rate of 1.0 C in the full cell, a short circuit occurred at cycle 179 in the case of bare lithium.

### Method of Preparing an Electrode (Anode)

A lithium disk was prepared by cutting lithium foil with a thickness of 200 μm into a diameter of 16 mm. An anode was prepared by depositing 12 nm of Zr-based metallic glass onto the lithium disk using magnetron sputtering. The sputtering was performed at DC 125 W for 45 seconds, in a sputtering Ar (99.999%) 5×10⁻⁵ Torr environment.

### Method of Preparing a Cell

For preparing a full-cell, CR2032 coin cells were used, and the cells were prepared inside a glove box under an Ar atmosphere (O₂<1 ppm, H₂O<1 ppm). 1M lithium bis(trifluoromethanesulfonyl)imide (LiTFSI) in 1:1 1,3-dioxolane/1,2-dimethoxyethande (DOL/DME) with 2 wt % lithium nitrate(LiNO₃) was used for the electrolyte, and LiFePO₄ (LFP:Super P:PVDF=8:1:1) with a capacity of 1.5 mAh/cm² was used for the cathode. The full cell was prepared in the order of a case, an anode (Zr-based MG/Li with a diameter of 16 mm), a separator (Celgard 2400), 70 μL of electrolyte, a gasket, a cathode (LFP with a diameter of 14 mm), a spacer, a wave spring, and a cap.

### [Cell Test Conditions]

Full cell testing was performed at a rate of 1.0 C and a voltage range of 3.0 V-3.8 V.

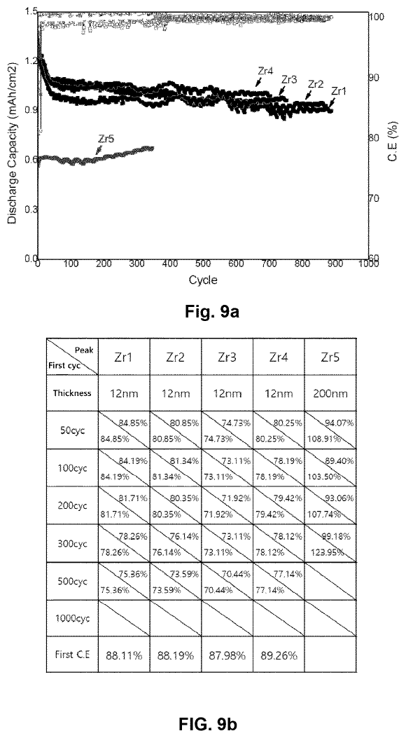

Referring to FIGS. 9(a) and 9(b), in the lithium metal secondary battery, under the conditions of 1.5 mA/cm², an electrolyte of DOL/DME 1M LiTFSI+2 wt % LiNO₃, and a charge/discharge rate of 1.0 C in the full cell, it can be seen that the anode coated with a Zr-based amorphous metal alloy exhibits a larger initial capacity and a larger capacity in the region where the capacity remains stable compared to bare lithium.

### Method of Preparing an Electrode (Anode)

A lithium disk was prepared by cutting lithium foil with a thickness of 200 μm into a diameter of 16 mm. An anode was prepared by depositing 5 nm of Ti-based metallic glass onto the lithium disk using magnetron sputtering. The sputtering was performed at DC 125 W for 45 seconds, in a sputtering Ar (99.999%) 5×10⁻⁵ Torr environment.

### Method of Preparing a Cell

For preparing a full-cell, CR2032 coin cells were used, and the cells were prepared inside a glove box under an Ar atmosphere (O₂<1 ppm, H₂O<1 ppm). 1M lithium bis(trifluoromethanesulfonyl)imide (LiTFSI) in a 1:1 1,3-dioxolane/1,2-dimethoxyethane (DOL/DME) with 2 wt % lithium nitrate (LiNO₃) was used for the electrolyte, and LiFePO₄ (LFP:Super P:PVDF=8:1:1) with a capacity of 1.5 mAh/cm² was used for the cathode. The full cell was prepared in the order of a case, an anode (Ti-based MG/Li with a diameter of 16 mm), a separator (Celgard 2400), 70 μL of electrolyte, a gasket, a cathode (LFP with a diameter of 14 mm), a spacer, a wave spring, and a cap.

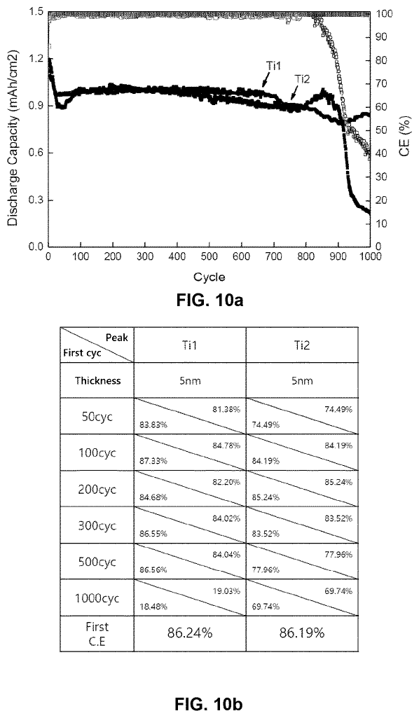

Referring to FIGS. 10(a) and 10(b), in the lithium metal secondary battery, under the conditions of 1.5 mA/cm², an electrolyte of DOL/DME 1M LiTFSI+2 wt % LiNO₃, and a charge/discharge rate of 1.0 C in the full cell, it can be seen that the anode coated with a Ti-based amorphous metal alloy also exhibits a larger initial capacity and a larger capacity in the region where the capacity remains stable compared to lithium.

The present invention is not limited to the above-described examples, but may be fabricated in various different forms, and those skilled in the art to which the present invention pertains will understand that the invention may be embodied in other specific forms without changing the technical spirit or essential features of the present invention. Therefore, the examples described above are to be understood as illustrative in all respects and not restrictive.

1. An anodeless lithium secondary battery comprising an amorphous metal alloy coating layer, the anodeless lithium secondary battery comprising:
a cathode;
a current collector facing the cathode and formed of copper foil;
an electrolyte located between the cathode and the current collector; and
a separator separating the cathode and the current collector,
wherein an interface where the current collector comes into contact with the electrolyte is coated with an amorphous metal alloy.

2. The anodeless lithium secondary battery comprising an amorphous metal alloy coating layer according to claim 1, wherein the amorphous metal alloy is a Zr-based amorphous metal alloy.

3. The anodeless lithium secondary battery comprising an amorphous metal alloy coating layer according to claim 2, wherein the Zr-based amorphous metal alloy is a compound of ZrₓCu_{y}Ni_{z}Al_{w}, wherein x is in a range of 35 to 70, y is in a range of 20 to 50, z is in a range of 7 to 15, and w is in a range of 3 to 5.

4. The anodeless lithium secondary battery comprising an amorphous metal alloy coating layer according to claim 1, wherein the amorphous metal alloy is a Ti-based amorphous metal alloy.

5. The anodeless lithium secondary battery according to claim 4, wherein the Ti-based amorphous metal alloy is a compound of TiₐZr_{b}Si_{c}, wherein a is in a range of 45 to 85, b is in a range of 20 to 50, and c is in a range of 5 to 10.

6. The anodeless lithium secondary battery comprising an amorphous metal alloys according to claim 1, wherein a coating thickness of the amorphous metal alloy is in a range of 8 to 500 nm.

7. (canceled)

8. (canceled)

9. (canceled)

10. (canceled)
